(19) United States
(12) Patent Application Publication
(10) Pub. No.: US 2004/0142082 A1
(43) Pub. Date: Jul. 22, 2004

(54) Cooking apparatus and method therefor

(76) Inventors: David Friedl, Montreal (CA); Nitai Friedman, Montreal (CA); Kenneth M. Buckley, Point Claire (CA)

Correspondence Address: PAUL J. NYKAZA, ESQ., WALLENSTEIN WAGNER & ROCKEY, LTD., 53RD FLOOR, 311 SOUTH WACKER DRIVE, CHICAGO, IL, 60606-6630, US

(21) Appl. No.: 10/690,490

(22) Filed: Oct. 21, 2003

Related U.S. Application Data
(63) Continuation-in-part of application No. 10/119,639, filed on Apr. 10, 2002.

(51) Int. Cl. A23C 3/00

(52) U.S. Cl. 426/523

(57) ABSTRACT

An apparatus (10) for cooking a food item (12) therein is disclosed. The apparatus (10) has a housing (14) defining an interior (16) and includes at least first and second opposed walls (18,20). A rotating member (22) is positioned between the first and second walls (18,20) of the housing (14), and the rotating member (22) is capable of engaging and rotating the food item (12). A drive mechanism (24) is mounted on the apparatus (10) for rotating the rotating member (22). A heating element (26) is positioned adjacent the second wall (20) of the housing (14), and a blackbody radiator (30) is positioned between the rotating member (22) and the heating element (26). The heating element (26) heats a first side (31) of the blackbody radiator (30) and a second side (33) of the blackbody radiator (30) emits radiation in a highly effective wavelength spectrum toward the food item (12). The apparatus (10) also includes a self cleaning system (40) for cleaning the interior (16).

### RELATED APPLICATIONS

The present application is a continuation-in-part application of and claims the benefit of non-provisional application Ser. No. 10/119,639 filed on Apr. 10, 2002, which application is incorporated by reference herein and made a part hereof.

### TECHNICAL FIELD

The present invention relates to a cooking apparatus and method therefor, and to a system and method for self-cleaning the cooking apparatus. In addition, the invention relates to a cooking apparatus having an angled burner with a drain hole and an enhanced self-cleaning system.

### BACKGROUND OF THE INVENTION

Rotisserie ovens are well-known. There are generally two basic rotisserie oven designs:

1) vertical; and 2) carousel/dual rotation. Each design can employ either a gas or electric burner.

The vertical oven design incorporates an array of skewers positioned vertically adjacent to the back wall of the unit. A plurality of heating elements, similar to the number of skewers are positioned adjacent to the back wall of the oven and between the array of skewers and the back wall. These elements emit energy onto the product as it rotates in front of the heating elements. These heating elements are generally electric heating elements, gas burners or any combination thereof. Furthermore, to enhance the cooking process, it is desirable to have a large surface area emitting radiation. Electric heating elements are generally thin and, therefore, have little surface area for emitting radiation.

The dual rotation oven design generally incorporates a planetary gear arrangement that serves as the drive mechanism. This drive mechanism is mounted within the interior cavity of the oven. In the example of a conventional gas rotisserie, there is generally a primary heat source that consists of an infrared heating element, mounted adjacent to the front wall in the upper portion such that the energy emitting from the burner is directed towards the product. This infrared burner is generally constructed from ceramic or Inconel sheathed material. Optionally, positioned adjacent to the back wall near the bottom of the rotisserie is a tubular-burner, heating element. As the product being cooked rotates within the cooking cavity, it is periodically exposed to the intense searing heat from the infrared burner as it passes. In such designs, the heating elements are sometimes required to generate heat to 1600 degrees Fahrenheit. High temperature heat is required to keep both the ignition system and the burners operating, as well as to heat the cooking cavity and the large cold mass. For example, the large cold mass can consist of 40 chickens, each weighing approximately 3 pounds, that must be raised from 38 degrees Fahrenheit to 185 degrees Fahrenheit during the cooking process.

The carousel oven consists of a drive mechanism that supports the product as it is being rotated within the cavity of the oven, allowing the product to hang freely while supported on both ends. Generally, carousel ovens utilize electric elements as the heat source. In the example of a conventional electric rotisserie, the electric heating elements are mounted in a plurality of positions throughout the interior cavity adjacent to the interior roof structure, the front wall and the back wall of the rotisserie. These elements are positioned such that they attempt to provide even heat distribution to all surfaces of the product.

In addition, current rotisseries are incapable of self-cleaning (spray-down), without subjecting the rotisserie components to water damage. For example, open-faced burners, spark/pilot ignition systems and ceramics used in these ovens are susceptible to water damage. This prevents spray down capability.

Thus, conventional ovens do not include self-cleaning (spray down) systems due to an inability to tolerate fluids within the oven. The cooking apparatus of the present invention is designed with components capable of tolerating a spray-down cleaning system. Notwithstanding, certain problems may still arise with internal components of the cooking apparatus when using a spray down cleaning system.

The present invention is provided to solve these and other problems as well as provide certain features not heretofore available.

### SUMMARY OF THE INVENTION

The present invention provides an oven for cooking a food item therein. The oven utilizes blackbody radiation to cook a food item placed therein. The oven has a housing defining an interior of the oven, a rotating member, a drive mechanism, a heating element and a blackbody radiator. A blackbody is any material that once heated to certain temperatures, emits radiation energy at a highly effective wavelength for cooking food products. In one preferred embodiment, the oven is a rotisserie oven.

The housing includes a first wall and a second wall opposite the first wall, a top and bottom. The housing also has a first aperture for providing airflow into the heating element and a second aperture for providing airflow out of the housing. Preferably, the housing has a door adjacent the first wall of the housing to allow an operator to access the food item therein.

The rotating member is positioned between the first and second walls of the housing. The rotating member engages and rotates the food item in either a clockwise or a counterclockwise direction. Preferably, the rotating member is a skewer. The drive mechanism is mounted on the oven for rotating the skewer.

In one preferred embodiment, the heating element is positioned adjacent the second wall of the housing, and the blackbody radiator is positioned between the rotating member and the heating element. Preferably, the blackbody radiator is modulated at various temperatures to achieve various results. Preferably, the blackbody radiator has a plurality of tabs for gathering heat emanating from the heating element and spreading the heat into the blackbody radiator. For the process of cooking, the temperature that the blackbody radiator remits radiation effectively for cooking food, within the 3-10 μm wavelength, is in the range of 400-1400 degrees Fahrenheit. At this temperature range, 60% of the blackbody radiation is within the 3-10 micrometer range, with peak effectiveness in excess of 70% at approximately 900 degrees Fahrenheit.

The blackbody radiator emits radiation toward the rotating member to cook the food item. Preferably, the blackbody radiator is curve-shaped, or is in a similar plane as the product being cooked or otherwise profiled to provide a larger radiation surface to the product. The blackbody radiator is made from materials that have strong emissivity (i.e., ability to emit radiant energy) and are not water sensitive, nor damaged by the cleaning process. In one preferred embodiment, the blackbody radiator is made from steel. In another preferred embodiment, the blackbody radiator is made from iron. It is understood, however, that all steel/iron/alloy/metal variations are possible that emit radiant energy in the highly effective wavelength range for cooking food items.

According to another aspect of the invention, the rotisserie oven has a self-cleaning system. The self-cleaning system includes a system of jets that are capable of spraying cleaning solution and water into the cooking cavity of the oven. In one preferred embodiment, the jets are positioned within a main shaft of a drive mechanism of the oven. The cleaning system may be controlled by a separate controller.

According to another aspect of the invention, the rotisserie oven has a decorative flame positioned remote from the cooking cavity.

The present invention also provides a method of cooking a food item in an oven. The method includes providing an oven having a housing defining an interior of the oven and including a first wall and a second wall opposite the first wall. The oven has a rotating member positioned between the first and second walls of the housing, and a drive mechanism mounted on the oven. The oven has a heating element positioned adjacent the second wall of the housing, and a blackbody radiator positioned between the rotating member and the heating element. In one preferred embodiment, the blackbody radiator is a steel or iron radiator. An operator inserts the food item into the oven and the heating element heats one side of the blackbody radiator to a temperature between 400 and 1400 degrees Fahrenheit. The surface of the blackbody radiator emits dark infrared radiation toward the food item at a wavelength generally within the 3-10 micrometer range. The dark infrared radiation cooks the food item to its desired temperature.

According to another aspect of the invention, the oven includes a heating element that is a burner. The burner has a first end and a second end. The burner includes a plurality of apertures along the top surface of the burner, and a drain opening proximate the second end of the burner. The burner is mounted within the housing of the oven such that second end of the burner is lower than the first end of the burner to permit draining of fluids through the burner's drain opening.

According to yet another aspect of the invention, the oven includes a self-cleaning system having enhanced structural and operating features including independent fluid delivery, a self-cleaning filter, a cleaning system, a rinsing system, a safety lock system, a rear burner baffle, and a controller. The controller controls the self-cleaning system. The cleaning system delivers cleaning solution to the housing of the oven, while the rinsing system delivers rinsing fluid, such as water, to the housing. The safety lock system operates to ensure that the self-cleaning system is only activated within a desired temperature range. The rear burner baffle protects the burner from direct spray of fluids introduced by the cleaning and rinsing systems. The self-cleaning filter filters away debris and waste from the cleaning and rinsing solutions. The self-cleaning system features independent fluid delivery for the cleaning and rinsing systems, and a self-priming configuration.

Other features and advantages of the invention will be apparent from the following specification taken in conjunction with the following drawings.

### BRIEF DESCRIPTION OF THE DRAWINGS

FIG. 1 is a perspective view of a rotisserie oven;

FIG. 2 is a cross-sectional schematic view of an oven utilizing a blackbody radiator;

FIG. 3 is a cross-sectional schematic view of an embodiment of a rotisserie oven according to the present invention;

FIG. 4 is a cross-sectional schematic view of another embodiment of the rotisserie oven according to the present invention;

FIG. 5 is a cross-sectional schematic view of another embodiment of the rotisserie oven according to the present invention;

FIG. 6 is a cross-sectional schematic view of another embodiment of the rotisserie oven according to the present invention;

FIG. 7 is a spectral absorption curve for water;

FIG. 8 is a curve showing the percentage of infrared radiation emitted from a blackbody between 3-10 μm;

FIG. 9 is a cross-sectional view of a blackbody radiator according to the present invention;

FIG. 10 is a cross-sectional view of an alternative blackbody radiator;

FIG. 11 is a front elevation view of another embodiment of an oven depicting a self-cleaning system;

FIG. 12 is a perspective view of an embodiment of an oven with portions of the housing removed;

FIG. 13 is a front elevation view of the oven of FIG. 12;

FIG. 14 is a schematic end view of the oven of FIG. 12;

FIG. 15 is a perspective view of a blackbody radiator of the oven of FIG. 14;

FIG. 16 is a side elevation view of the blackbody radiator of FIG. 15;

FIGS. 17(a)-(c) are perspective views of another embodiment of an oven of the present invention;

FIG. 18 is a front elevation view of yet another embodiment of an oven of the present invention;

FIG. 19 is a side elevation view of the oven of FIG. 18;

FIG. 20 is a rear elevation view of the oven of FIG. 18;

FIG. 21 is a top view of the oven of FIG. 18;

FIG. 22 is a front perspective view of the oven of FIG. 18;

FIG. 23 is a rear perspective view of the oven of FIG. 18;

FIG. 24 is a sectional view along the line A-A of FIG. 18;

FIG. 25 is a sectional view along the line B-B of FIG. 21;

FIG. 26 is a partial perspective view of the second preferred embodiment of the oven of the present invention;

FIG. 27 is a front view of the oven of FIG. 26;

FIG. 28 is an end view of the oven of FIG. 26;

FIG. 29 is a top perspective view of the heating element of the oven of FIG. 26;

FIG. 30 is a bottom perspective view of the heating element of FIG. 29; and

FIG. 31 is a schematic diagram of a self-cleaning system and safety lock system of the oven of FIG. 26.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Referring now in detail to the Figures, FIG. 1 discloses a rotisserie oven that can incorporate the present invention.

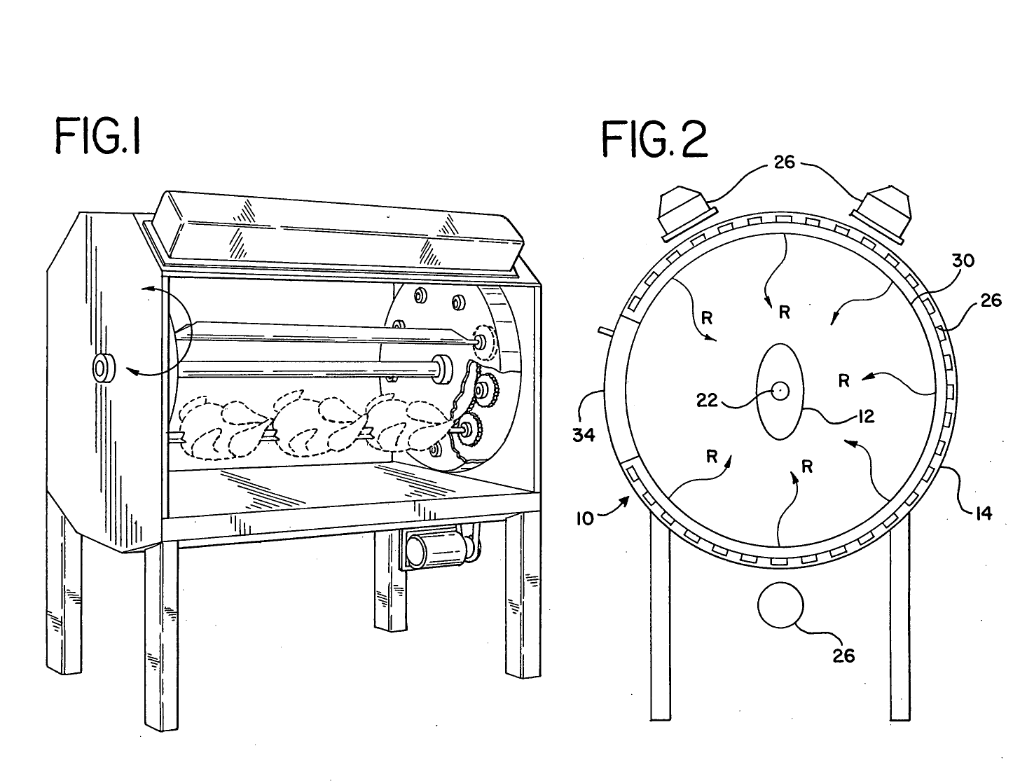

FIG. 2 illustrates an oven 10 for cooking a food item 12 according to the present invention. The oven 10 utilizes a blackbody radiator to cook the food item 12. The oven 10 generally includes a housing 14 in the form of a blackbody radiator 30, a skewer 22 and a heating element 26. The housing 14 is barrel-shaped and completely surrounds the food item 12. The housing 14 could take other forms. The housing 14 has an access door 34 for placing the food item 12 on the skewer 22 and in the housing 14. The heating element 26 can take different forms from a burner placed below the housing 14, an infrared burner placed above the housing 14, or an electric heating element embedded in the housing 14 or around the housing 14. The heating element 26, in any form, merely is required to heat the housing 14. Only a single heating element is required. Because the housing 14 takes the form of blackbody radiator 30, once heated, it will emit radiation R toward the food item 12 in a highly effective wavelength for cooking food, preferably in the 3-10 μm range. The amount of radiation emitted by the radiator 30 is maximized in a specific temperature range based on the type of blackbody radiator 30. For example, and as explained in greater detail below, an iron radiator can be used with a temperature in the range of 400-1400 degrees Fahrenheit. Because the housing 14 completely surrounds the food item 12, the maximum amount of radiation emitting surface area is achieved to cook the food item 12.

FIG. 3 illustrates an oven 10, such as a rotisserie oven 10, for cooking a food item 12 therein. The oven 10 generally includes a housing 14, a skewer 22, a drive mechanism 24, a heating element 26, and a blackbody radiator 30.

The housing 14 defines an interior 16 of the oven 10. The housing 14 has a first wall 18 and a second wall 20 opposite the first wall 18. Preferably, the first wall 18 has a door 34 for providing access to the food item 12 in the interior 16 of the oven 10. The housing further has a ceiling 21 positioned between the first wall 18 and the second wall 20. The ceiling has an exhaust opening 36. The second wall 20 has an air inlet opening 28. In one preferred embodiment, the housing 14 has a generally rectangular cross-section although it is understood that the housing 14 can take various other forms.

The skewer 22, or spit, is positioned between the first wall 18 and the second wall 20 of the housing 14. In a preferred embodiment, the oven 10 utilizes a plurality of skewers 22. The skewer 22 passes through and holds the food item 12 to be cooked. The drive mechanism 24 is mounted within the housing 14 and is connected to the skewers 22. The drive mechanism 24 rotates the skewer and food item 12 in a first clockwise or counterclockwise direction as indicated by the arrows in FIG. 3. The drive mechanism 24 can also rotate each individual skewer 22, as the skewers 22 move in the first direction. This assures that all sides of the food item 12, such as a chicken, are cooked uniformly. The heating element 26 is positioned adjacent the second wall 20 of the housing 14. In this embodiment, the heating element 26 is in the form of a gas-fired burner 26. However, the use of other heating elements is contemplated.

The blackbody radiator 30 is generally a member that is heated by the burner 26 to cook the food items 12. A blackbody is any material that once heated to specific temperatures, radiates energy in a highly effective spectrum. The blackbody surface, such as iron, stainless steel and any metal alloys, completely absorbs all radiant energy of any wavelength falling upon it with no reflection of energy. Use of the blackbody radiator 30 in cooking the food items 12 will be explained in greater detail below.

The blackbody radiator 30 is curved shaped, and or is in a similar plane as the product being cooked or otherwise profiled to present a larger radiation surface to the product. The blackbody radiator 30 can be comprised of separate members connected together such as by welding, or the blackbody radiator 30 could be made from a solid, integral member. The blackbody radiator 30 has a first side 31 and a second side 33. The blackbody radiator 30 also has a plurality of protruding members, such as a tab 32, attached to the second side 33 of the blackbody radiator 30 and protruding toward the second wall 20. The tab 32 may be welded to the blackbody radiator 30, or attached to the blackbody radiator 30 by other attachment means known to those skilled in the art. The blackbody radiator 30 can have a plurality of temperature sensors 38 placed on the radiator 30 for monitoring temperature. The blackbody radiator 30 is positioned within the housing 14 and generally between the skewers 22 and the second wall 20 of the housing 14. The blackbody radiator 30 is spaced from the second wall 20 and the burner 26 is positioned generally between the blackbody radiator 30 and the second wall 20. The second side 33 of the blackbody radiator 30 is heated by the burner 26. As explained in greater detail below, the radiative properties from the first side 31 of the blackbody radiator 30 are used to cook the food item 12. In one preferred embodiment, the blackbody radiator 30 is made of cast iron. Iron radiates energy in a highly effective spectrum for cooking food products. Other materials that radiate energy in an effective spectrum can also be used such as other metal alloys or stainless steel.

In operation, an open flame from the gas burner generates heat. Air enters the oven 10 through the air inlet opening 28 in the second wall 20. Heat rises from the burner 26 between the blackbody radiator 30 and the second wall 20. Preferably, the burner 26 heats the blackbody radiator 30 to a temperature in the range of 400 to 1400 degrees Fahrenheit to optimize cooking conditions. The tabs 32 assist the blackbody radiator 30 in reaching this temperature range by gathering heat from the heating element 26 and spreading the heat into the blackbody radiator 30. As the second side 33 of the blackbody radiator 30 is heated, the blackbody radiator 30 emits radiation from the first side 31 of the blackbody radiator 30 towards the skewers 22 to cook the food item 14. Exhaust from the burner 26 is allowed to escape through the opening 36.

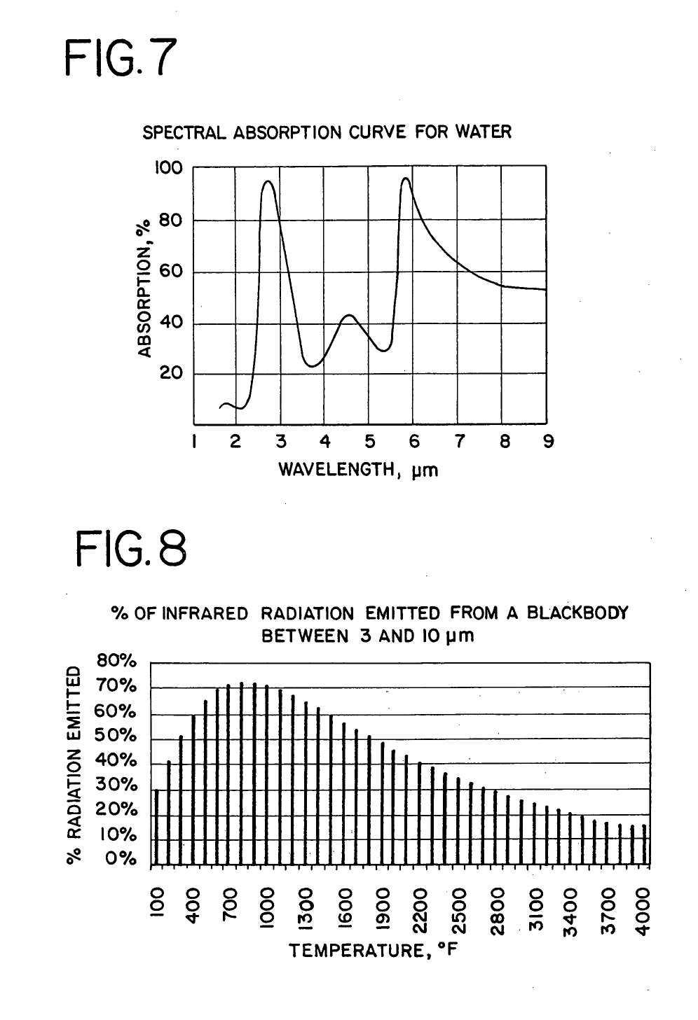

The food item 12 is cooked by absorbing radiation from the blackbody radiator 30. FIG. 7 discloses a spectral absorption curve for water. The curve shows that the greatest and deepest radiation absorption for water occurs generally when the radiation is at a wavelength of 3-10 μm. Most food items have a high percentage of water. For example, meats such as chickens are approximately 70% water. Accordingly, it is desirable for the blackbody radiator 30 to emit radiation at the 3-10 μm wavelength as the mass of chickens is comprised of a large percentage of water. This is the highly effective wavelength for cooking the majority of meat products. Blackbody radiators, such as the iron radiator 30, will emit radiation at this wavelength. FIG. 8 discloses a curve showing the percentage of infrared radiation emitted from a blackbody radiator between 3 and 10 μm wavelength. The greatest percentage of radiation emitted occurs generally within the range of 400-1400 degrees Fahrenheit. Thus, by controlling the heat in the blackbody radiator 30, its radiative properties are also controlled. This allows one to control the cooking process. By modulating the blackbody radiator 30, different cooking profiles can be achieved from intense searing heat to soft gentle heat that can give an even golden color. In a preferred embodiment, the blackbody radiator 30 is heated to approximately 900 degrees Fahrenheit to maximize the percentage of radiation emitted at the 3-10 μm wavelength.

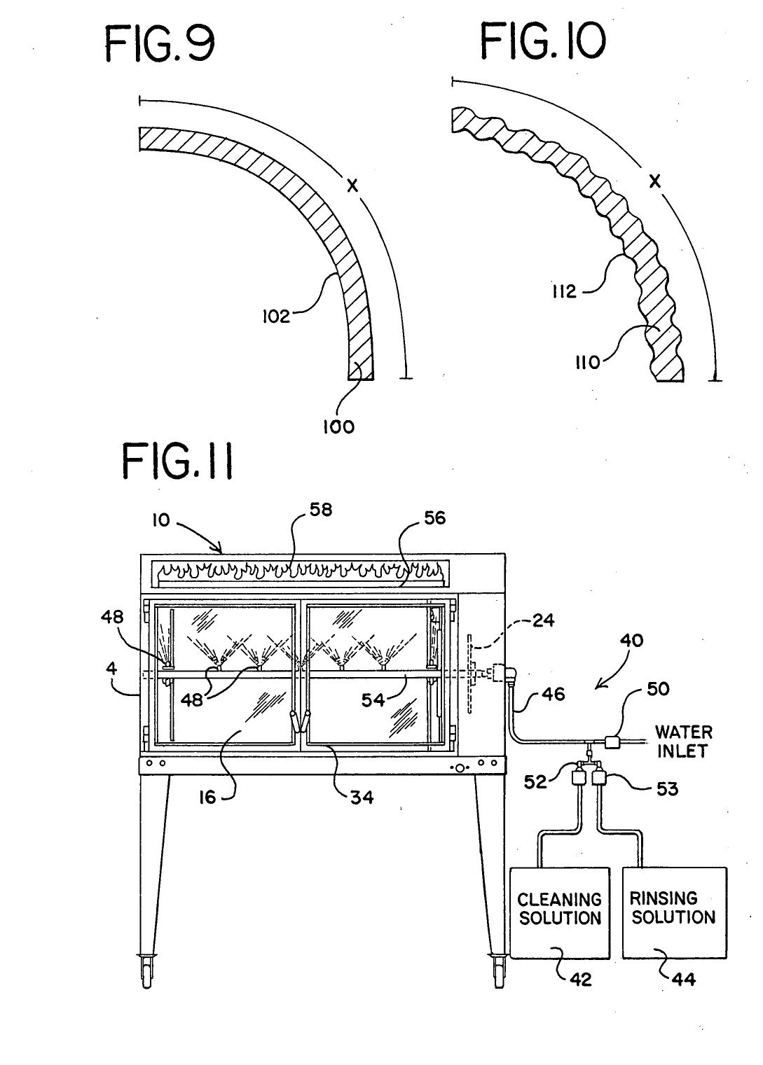

It is desirable to have as large a blackbody radiator 30 as possible. This increases the surface area that will emit radiation towards the food items 12 being cooked. It is further desirable to have as many interior surfaces of the oven to act as blackbody radiators. This further increases the surface area that will emit radiation to cook the food items. For example, the oven 10 of FIG. 2 is configured such that the entire housing 14 comprises the blackbody radiator 30, therefore, maximizing the surface area emitting radiation towards the food item 12. FIG. 9 discloses an iron radiator 100 similar to the iron radiator 30 utilized in the oven shown, for example, in FIG. 3. The radiator 100 has an inner surface 102 that is generally smooth and planar. The radiator 100 occupies a linear distance x. FIG. 10 discloses another radiator 110. The radiator 110 has a wavy inner surface 112. This increases the overall surface area of the inner surface 112. This increases the radiation emitting inner surface area 112 within the identical linear distance x.

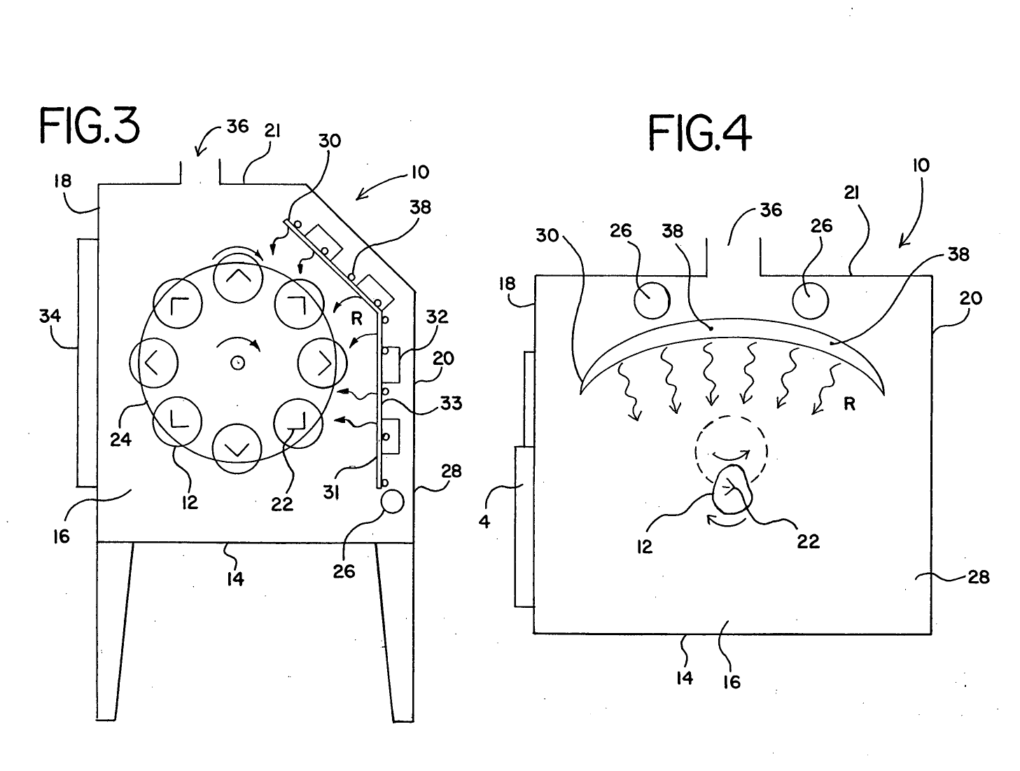

FIG. 4 illustrates an alternate embodiment of the oven 10 shown in FIG. 3. The heating element 26 is in the form of an infrared burner 26. In this particular embodiment, there are two infrared burners 26. The burners 26 are positioned adjacent the ceiling 21 of the housing 14. The blackbody radiator 30 is positioned below the burners 26. The blackbody radiator 30 also has a plurality of temperature sensors 38 for monitoring the temperature of the blackbody radiator 30. This embodiment is operated preferably within the parameters as described above. It is further understood that the oven 10 can have both a blackbody radiator 30 adjacent the second wall 20 and a blackbody radiator 30 adjacent the ceiling 21 to increase the cooking surfaces.

FIG. 5 illustrates another alternate embodiment of the oven 10 shown in FIG. 3. Similar to the embodiment illustrated in FIG. 2, the blackbody radiator 30 is positioned between the skewer 22 and the second wall 20 of the housing 14. However, unlike in FIG. 2, the heating element 26 is in the form of wire leads that are embedded within the blackbody radiator 30. Moreover, the blackbody radiator 30 has a plurality of temperature sensors 38 for monitoring the temperature of the blackbody radiator 30.

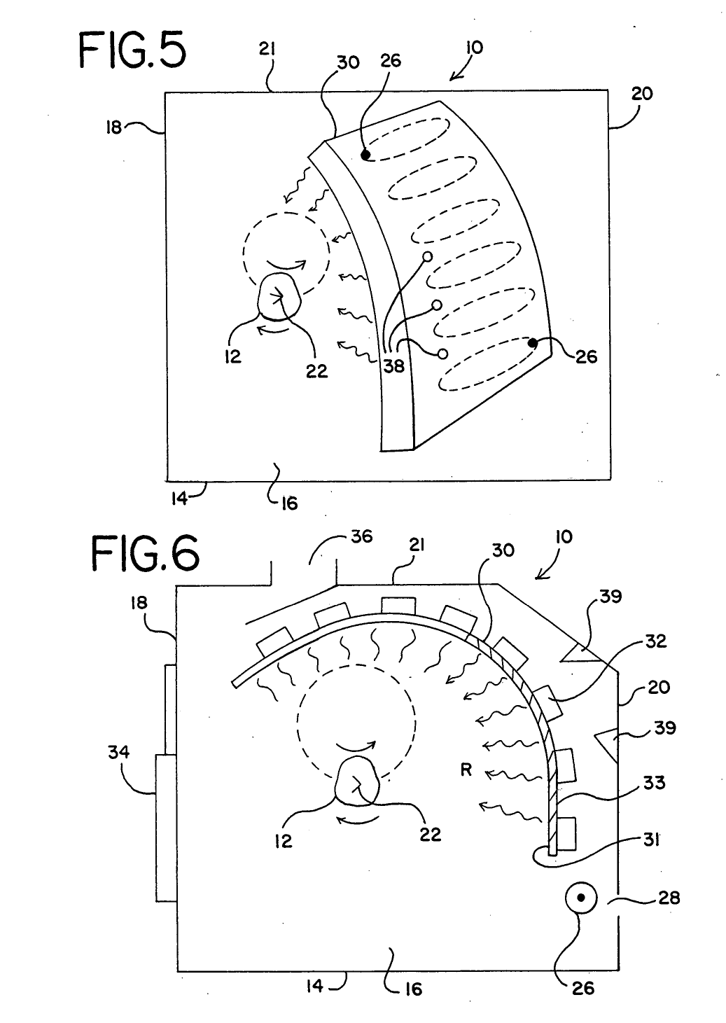

FIG. 6 illustrates yet another embodiment of the oven 10. The blackbody radiator 30 extends from the second wall 18 to across the ceiling 21 of the housing 14. A front portion of the blackbody radiator 30 slopes towards the front of the housing 14. The blackbody radiator 30 is shaped to provide a partial encapsulating configuration for the food item 12. This increases the radiation emitting surface area of the radiator 30. Also, air deflectors 39 are positioned on the second wall 18 and ceiling 21. The air deflectors direct heated air into the tabs 32 which, in turn, spread the heat into the blackbody radiator 30.

In another alternate embodiment of the oven 10 similar to the oven 10 shown in FIG. 1 or 3, the second wall 20 of the housing 14 can comprise the blackbody radiator 30. The heating element 26 is positioned within the second wall 20 of the housing 14, and the second wall 20 is directly heated and emits blackbody radiation. Likewise, the ceiling 21 of the housing 14 may comprise the blackbody radiator 30. Thus, it is contemplated that the housing 14 itself can comprise a blackbody radiator.

A method of cooking a food item in an oven is also disclosed. The method includes providing an oven having a housing defining an interior of the oven and including a first wall and a second wall opposite the first wall. The oven has a rotating member positioned between the first and second walls of the housing, and a drive mechanism mounted on the oven. The oven has a heating element positioned adjacent the second wall of the housing, and a blackbody radiator positioned between the rotating member and the heating element. An operator inserts the food item into the oven and the heating element heats the second side 33 of the blackbody radiator to a temperature between 700 and 1100 degrees Fahrenheit. The first side 31 of the blackbody radiator 30 emits blackbody radiation toward the food item. The blackbody radiation cooks the food item to its desired temperature. It is understood that the heating elements could be gas, electric or other energy sources, including but not limited to other conductive designs.

A method can also include heating the blackbody radiator 30 to approximately 900 degrees Fahrenheit. The food item 12 is heated until an internal temperature of 185 degrees Fahrenheit is reached and its outer surface has a nice golden brown color. The heat is gradually removed from the radiator 30. At the end of the process, the radiator 30 is not heated for a short period of time while the food item remains in the oven to complete the cooking process.

Further, a method of self-cleaning a rotisserie oven without damaging components therein is disclosed. Using the blackbody radiator 30 eliminates the need for using open-faced burners, spark/pilot ignition systems and ceramic heating members. These items are susceptible to water damage. Because the oven 10 does not utilize these elements, the oven 10 can be sprayed down with a cleaning solution.

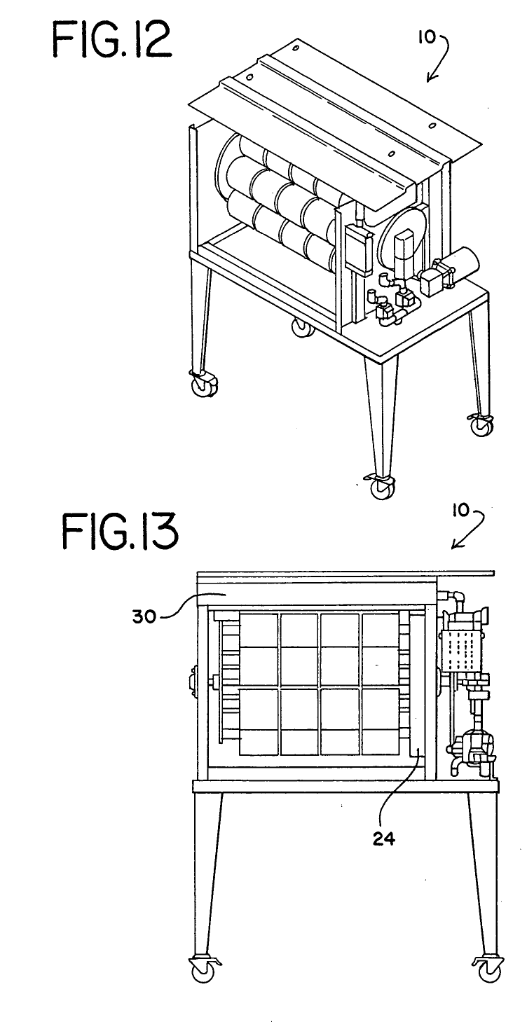

FIG. 11 depicts one preferred embodiment of a self or auto-cleaning system 40. The system includes a controller (not shown), a cleaning solution reservoir 42, a neutralizing or rinsing solution reservoir 44, a water source (not shown), a delivery conduit 46 and a plurality of jets 48. The water source is connected to the delivery conduit 46 via a water solenoid 50. The cleaning solution reservoir 42 is connected to the delivery conduit via delivery pump 52 and the rinsing solution reservoir 44 is connected to the delivery conduit 46 via dispensing pump 53. In a most preferred embodiment, the delivery conduit 46 is in turn connected to a main or center shaft 54 of the drive mechanism 24. The center shaft 54 is generally tubular. The plurality of jets 48 are mounted to the center shaft 54. The delivery conduit 46, center shaft 44 and jets 48 together form part of a flow path of the auto-cleaning system 40. It is understood that the jets 48 could be mounted at other locations in the oven 10.

During the cleaning cycle, the controller opens the water solenoid 50 for a pre-determined period of time and water flows into and through the delivery conduit 46, center shaft 54 and out through the jets 48. The center shaft 54 is rotated generally concurrently with the opening of the water solenoid 50 to permit maximum coverage of the interior 16 of the housing 14. The controller then meters cleaning solution having a de-greasing agent into the system 40 via pump 52. Water flowing through the delivery conduit 46 causes the cleaning agent to likewise flow though the delivery conduit 46, the center shaft 54 and out through the jets 48. Due to the rotation of the center shaft 54, the cleaning agent coats substantially all surfaces of the interior 16 of the housing 14. The cleaning agent aids in the removal of baked on carbon and food product 12 deposits resulting from the previously described cooking process. When the desired coverage is reached, the controller may shut down the pump 52 and the solenoid 50 and stop rotation of the center shaft 54 for a predetermined period of time. This allows the cleaning agent sufficient time to act on the carbon and food deposits.

Then the controller will again open water solenoid 50 and begin rotation of the center shaft 54 to begin the rinsing portion of the cycle. Additionally, the controller meters a rinsing solution having a neutralizing agent for pH concerns into the system via pump 53. As mentioned, pump 53 connects the rinsing solution reservoir 44 to the delivery conduit 46. Water flowing through the delivery conduit 46 causes the rinsing solution to likewise flow though the delivery conduit 46, the center shaft 54 and out through the jets 48. Due to the rotation of the center shaft 54, the rinsing solution coats substantially all surfaces of the interior 16 of the housing 14. The rinsing solution assists in rinsing the carbon and food deposits and any remaining cleaning agent, out of the housing. The controller then turns off pump 53. The water solenoid remains open for a period of time to allow the system to be completely flushed of any cleaning or rinsing solution and to allow the interior 16 of the housing 14 to be completely flushed of carbon and/or food deposits and of any remaining de-greasing agent.

Other embodiments of the auto-cleaning system 40 may include rotating spray heads or nozzles in place of or in addition to the described jets 48. Additionally, fixed heads may be placed in critical areas or hard to clean areas to reach certain carbon/food deposits of the cooking cycle.

FIGS. 11 and 14 show an enclosed plenum 56 for housing a decorative flame 58. The decorative flame 58 is positioned generally remote from the cooking cavity of the housing 14 of the oven 10. The enclosed plenum 56 is generally located between the first wall 18 and second wall 20 of the housing 14 immediately above the access door 34. The plenum 56 is separate from the rest of the interior 16 of the housing 14. The decorative flame 58 provides an increased visual enhancement of the oven 10. The decorative flame 58 is positioned such that its view is not obstructed by food product within the oven 10. In alternative embodiments, the decorative flame 58 may be located elsewhere within the interior 16.

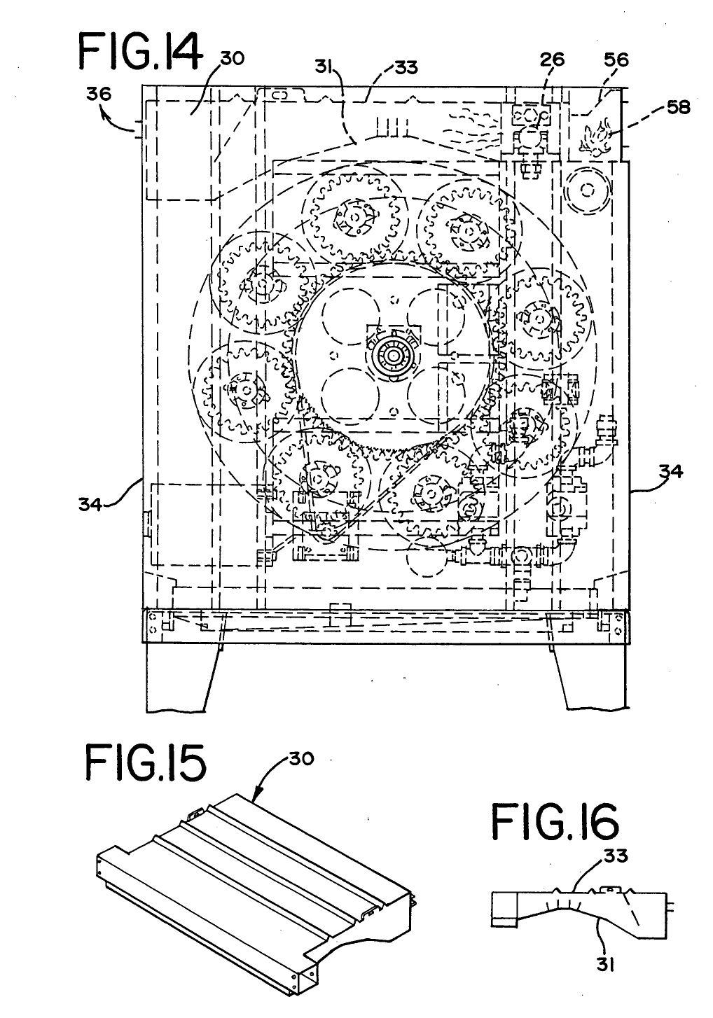

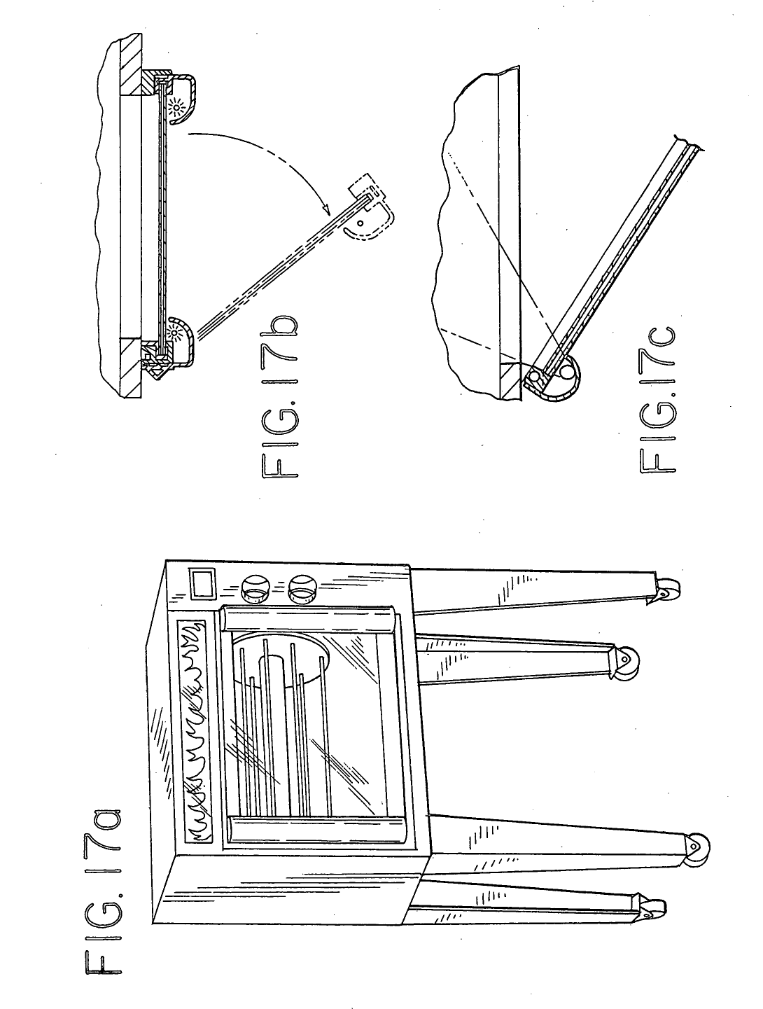

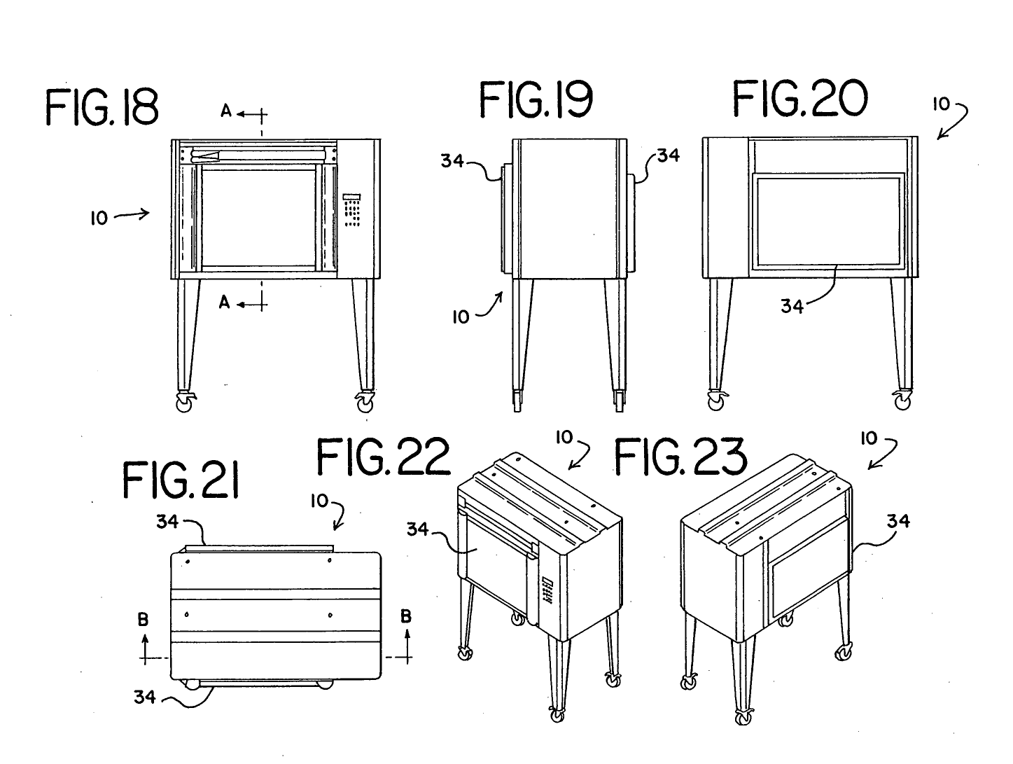

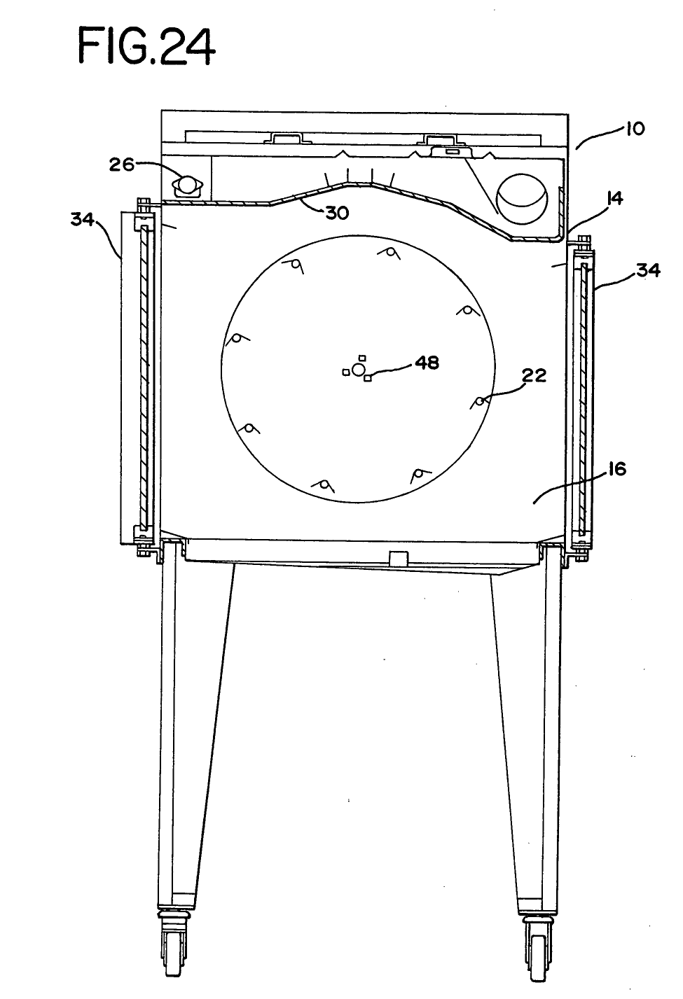

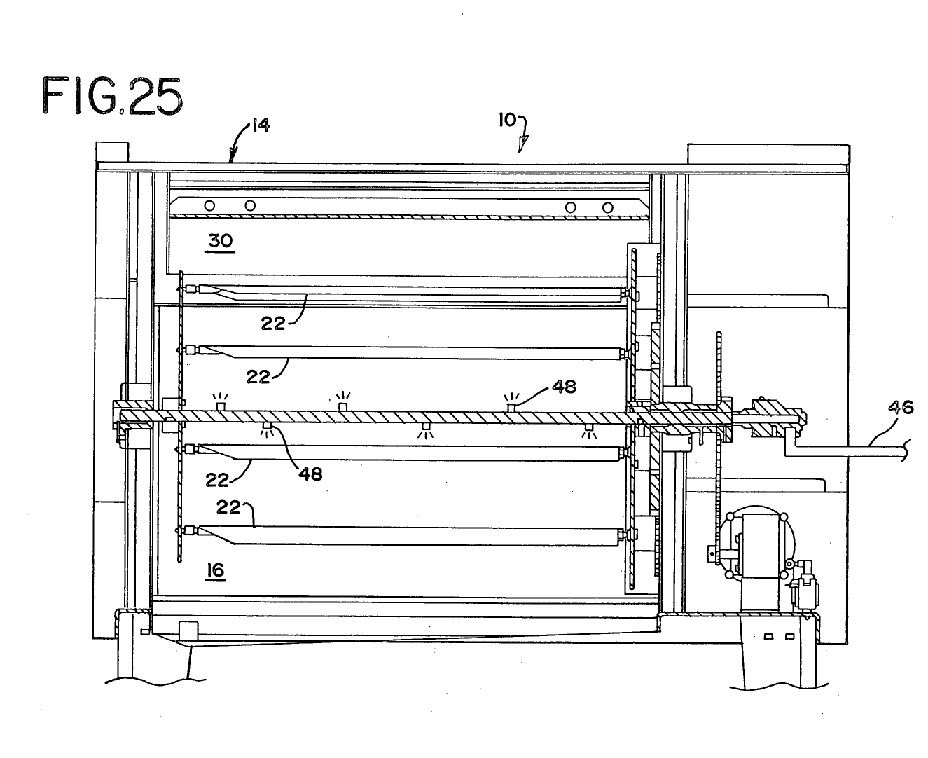

FIGS. 12-25 show another preferred embodiment of the oven 10 of the present invention. FIGS. 18-21 show various views of the oven. As shown in FIGS. 14, 19 & 21, the oven 10 has both front and rear access doors 34 wherein the oven constitutes a pass-through design. As shown in FIGS. 17(a)-(c), the front door 34 and/or rear door 34 may have integral lighting. FIGS. 15, 16 & 24 generally show the blackbody radiator 30. FIG. 24 shows a cross sectional view along the line A-A of FIG. 18 and FIG. 25 shows a cross sectional view along the line B-B of FIG. 21. FIG. 25 further shows the planetary gear system driven by gear motor. The delivery conduit 46 for the auto-cleaning system is connected to a rotary joint at an end of the center shaft 54 having cleaning jets 48. As shown, the blackbody radiator 30 is located at or near the top of the interior of housing 14. Accordingly, the heating element 26, in the form of a burner, is also located near the top of the interior 16. This orientation of the heating element 26 has several advantages.

In known rotisserie ovens, the heating element 26 has been located near the bottom of the interior 16. In such a location, the heating element 26 heats the entire interior 16 and all surfaces thereof to high temperatures. Without the use of proper caution, this has the potential to create a hazardous condition for an operator of the oven 10 in the form of an increased risk of burn or other injury. Also, while it is known to have front and rear access doors 34 in a rotisserie oven, their usefulness is severely hampered by the location of the a heating element 26 near the bottom of the interior 16. This is due to the proximity of the heating element to either or both of the access doors 34.

In locating the heating element 26 near the top of the interior 16, the temperature of the interior during the cooking cycle is reduced as compared to that of known ovens. This eliminates the need for a cool down period and reduces the risk of burns or other injury to an operator of the oven 10. This improves the ability of operators to use both access doors 34 as no heat source is located in close proximity to either door 34.

The present invention controls the heat in the blackbody radiator 30, and thus, effectively controls the radiative properties from the radiator. Because the present invention provides the ability to control the radiative properties from the blackbody radiator, the cooking process is, therefore, also controlled. The blackbody radiator 30 can be adjusted to allow for different cooking profiles ranging from intense searing heat to soft gentle heat that give even golden color. Preferably, the back wall and the top of the housing act as blackbody radiators. This greatly increases the surface area of the housing that emits radiation for cooking. In other designs, such as a pass-through design, where the oven has two doors, one each on opposite sides of the housing, only the top of the housing acts as a blackbody radiator. Other designs may include reflective surface on the doors to increase surface area of product exposed to blackbody effects. By incorporating as much of the cooking cavity as the blackbody radiator, and by providing the energy in a focused way, drastically lowered cook times are achieved.

By using the blackbody radiator, such as the iron radiator 30, radiation is emitted in the highly effective spectrum, namely, in the 3-10 μm wavelength. The temperature that the blackbody emits radiation effectively for cooking food, within the 3-10 μm wavelength, is in the range of 400 to 1400 degrees Fahrenheit. At this temperature, 60% of the blackbody radiation is within the 3 to 10 μm range, with peak effectiveness in excess of 70% at the peak of the bell curve at 900 degrees Fahrenheit. In conventional designs, heat is used where radiation is emitted at an undesirable wavelength that cannot be as effectively absorbed by the food item. Higher temperatures are also required using more energy. Thus, in the present invention, the food items are cooked faster (i.e. greater radiation absorption) and with less energy. For example, in conventional rotisserie ovens using infrared burners, a normal time that 25-3½lb. chickens can be cooked is approximately 1 hour and 30 minutes. By using a blackbody radiator in accordance with the present invention, the same 25-3½lb. chickens can be cooked in only 45 minutes. Furthermore, because lesser temperatures are required, less energy is used. Thus, the energy is used in a more efficient manner.

The present invention utilizes blackbody radiation to cook food items. The invention is applicable to all cooking applications and includes applications that use variable temperature in the blackbody radiator to effectively cook food products. A rotisserie oven is one example of an oven that can utilize a blackbody radiator and includes various configurations ranging from vertical, horizontal, singular and plural skewer designs. The invention can also be utilized in any flat or vertical conveyorized designs, such as vertical ovens or pizza conveyor ovens.

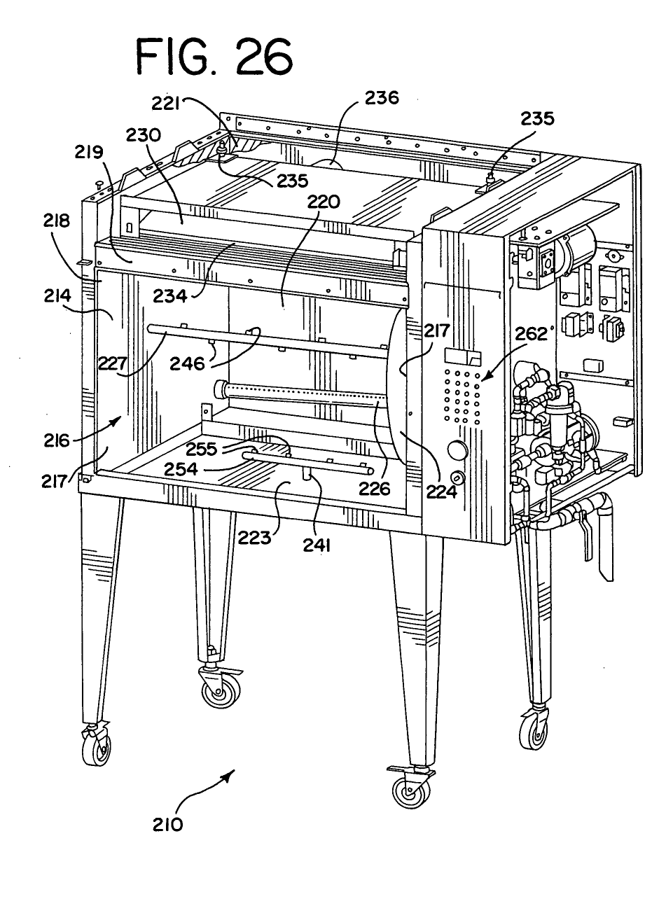

A second preferred embodiment of a cooking apparatus, or an oven of the present invention is disclosed in FIGS. 26-31, the oven generally referred to with the reference numeral 210. Elements of the second preferred embodiment that are substantially similar to corresponding elements of the first described preferred embodiment are referred to using similar reference numbers. Like the other embodiments, the oven 210 generally comprises a housing 214, a heating element 226, a cooking accessory such as a skewer (not shown, but see e.g. FIG. 17A) or food basket, a drive mechanism 224, a blackbody radiator 230, and a self or auto-cleaning system 240.

Referring to FIG. 26, the housing 214 defines an interior 216 of the oven 210. Certain portions of the oven 210 are removed from the FIGURES for clarity. The housing 214 is box-shaped and completely surrounds the food item (See FIG. 1). The housing 214 could take other forms. The housing 214 has a first wall 218, a second wall 220 opposite the first wall 218, and a pair of sidewalls 217. The first wall 218, second wall 220, and sidewalls 217 cooperate to define the interior 216 of the housing 214. Preferably, the housing 214 forms a water-tight shell. Preferably, the housing 214 has a door (not shown, but see e.g. FIG. 17A) positioned in the first wall 218 for providing access to the food item 212 in the interior 216 of the oven 210. The first wall 218 of the housing 214 also includes a crossbeam 219 extending into the interior 216 of the oven 210 and between the sidewalls 217 of the housing 214. The housing 214 further has a ceiling 221 positioned between the first wall 218 and the second wall 220. The housing 214 has an exhaust opening 236, preferably located in the second wall 220. The second wall 220 also has an air inlet opening 228. The housing 214 also includes a bottom surface 223 generally opposite the ceiling 221. The bottom surface 223 generally defines a plane. The bottom surface 223 of the housing 214 includes a discharge opening 225. In one preferred embodiment, the housing 214 has a generally rectangular cross-section although it is understood that the housing 214 can take various other forms.

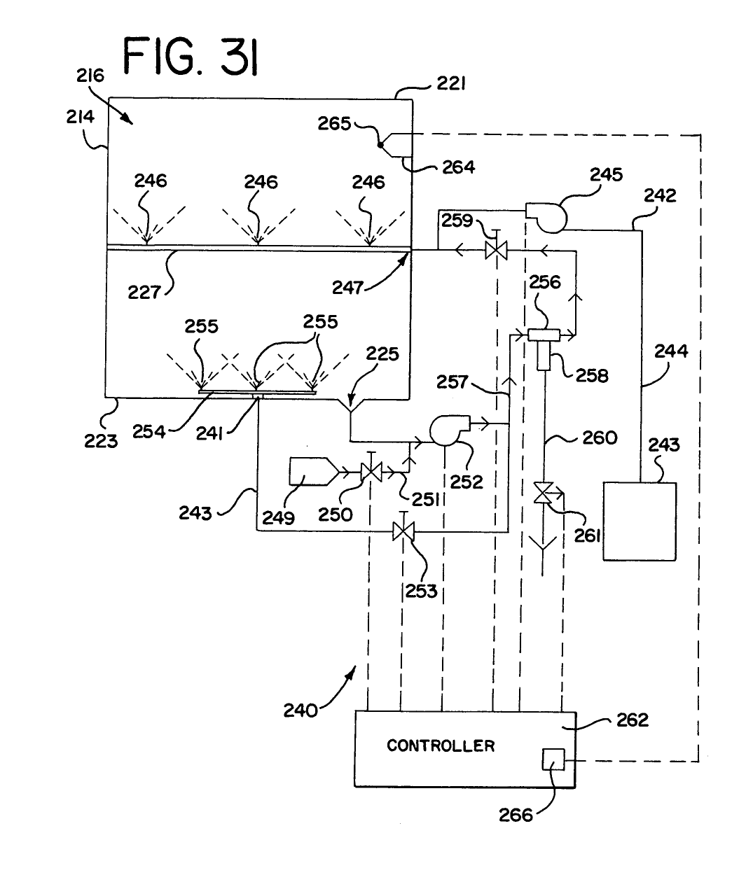

Positioned within the housing 214 is a heating element 226, which preferably is a burner. Preferably, the heating element 226 is positioned in an angled or tilted position proximate the bottom surface 223 of the housing 214, near the second, or rear wall 220, as seen in FIG. 26. Referring to FIGS. 29 and 30, the heating element 226 generally comprises a body 272 and an igniter assembly 286. The body 272 of the heating element 226 has a first end 274, a second end 276, a top surface 278, and a bottom surface 280. The body 272 is generally a hollow tubular structure having an annular cross-section. The length of the body 272 has a generally linear configuration. However, the body 272 can take on other configurations, such as circular, curved, “V”-shaped,” or “U-shaped.” Preferably, the first end 274 of the body 272 is open while the second end 276 of the body 272 is closed, or capped. The body 272 has a length between the first end 274 and the second end 276. The top surface 278 of the body has a plurality of apertures 282 arranged generally along the length of the body 272. The bottom surface 280 of the body 272 includes a drain opening 284. Preferably, the drain opening 284 is proximate the second end 276 of the body 272. The burner 226 is operably connected to a fuel source which is ignited and burns through the apertures 282.

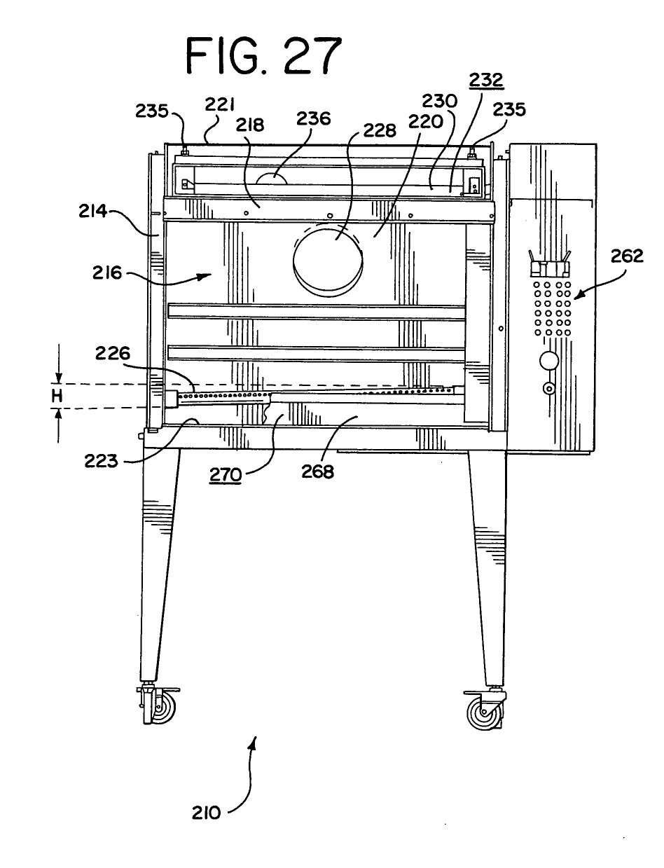

The angled or tilted configuration of the burner 226 assists in the cleaning cycle as described in greater detail below. Specifically, the burner 226 is mounted within the housing 214 in an angled or titled position between the sidewalls 217. As seen in FIG. 26, the burner 226 is mounted within the housing 214 proximate the bottom surface 223. When the burner 226 is mounted, the first end 274 of the body 272 of the burner 226 is raised above the second end 272 of the body 272 of the burner 226. Thus, the first end 274 of the body 272 is closer to the ceiling 221 of the housing 214 than the second end 276. Stated differently, the second end 276 of the body 272 is closer to the bottom surface 223 of the housing 214 than the first end 274 of the body 272. This results in the body 272 having a pitched, angled or titled configuration. The second end 276 being lower than the first end 274 causes fluids which may enter the body 272 of the burner 226 to flow, under the force of gravity, towards the second end 276 of the body 272 of the burner 226, where the drain opening 284 is positioned. Thus, the pitched configuration of the body 272 of the burner 226 works in conjunction with the drain opening 284 to feed the excess fluid in the body 260 towards the drain opening 284 where it can be drained from the body 272 of the burner 226. In the second preferred embodiment, the second end 276 of the body 272 is most preferably approximately one-quarter inch (1/4 inch) closer to the bottom surface 223 of the housing 214 than is the first end 274 of the body 272. As seen in FIG. 27, this creates a height differential (H) of approximately 1/4 inch. Stated differently, preferably the burner 226 is positioned within the housing 214 with approximately a 7 degree slope from horizontal, such that fluids within the body 272 of the burner 226 flow towards the drain opening 284.

The drain opening 284 assists during the cleaning cycle as will be described in greater detail below. Because a majority of the apertures 282 in the body 272 are not protected by the splash guard 292, the cleaning and rinsing solutions which are sprayed within the housing 214 may enter the body 272 through the apertures 282 on the top surface 278 of the body 272 of the burner 226. The drain opening 284 on the bottom surface 280 of the body 272 of the burner 226 allows the solutions which enter the body 272 to drain out of the body 272. Allowing these fluids to drain via the drain opening 284 keeps the body 272 of the burner 226 free of fluids. This improves the functioning of the burner 226. When the oven 210 is operated again after the cleaning cycle is complete, fuel enters the body 272 of the burner 226 and is again ignited by the igniter 290. Stagnant fluids, such as cleaning and rinsing solutions, if retained in the body 272 of the burner 226 would impede the flow of fuel through the burner 226, and hence would interfere with proper functioning of the oven 210 following the cleaning cycle. Furthermore, these stagnant fluids would corrode the interior surfaces of the body 272 of the burner 226, causing a reduced lifespan of the burner 226. The drain opening 284 in the body 272 significantly reduces the risk of these undesirable occurrences.

FIGS. 29 and 30 show the igniter assembly 286 of the heating element 226. The igniter assembly 286 is operably connected to the body 272, preferably in communication with the first end 274 of the body 272. The igniter assembly 286 generally comprises a base 288, an igniter 290, and a splash guard 292. The base 288 of the igniter assembly 286 is connected to the body 272, proximate the first end 274 of the body 272. The igniter 290 extends from the base 288 generally parallel to the body 272. The igniter 290 is positioned on the base 288 such that the igniter 290 is in communication with the apertures 282 on the top surface 278 of the body 272.

The splash guard 292 extends from the base 288 of the igniter assembly 282 so as to cover the igniter 290. Thus, the igniter 290 is positioned generally between the splash guard 292 and the body 272. The splash guard 292 comprises a top surface 294, a bottom surface 296, and a pair of end lips 298, 299. The top surface 294 of the splash guard 292 faces generally away from the igniter 290 and body 272, while the bottom surface 296 of the splash guard 292 faces generally towards the igniter 290 and body 272. The first end lip 298 of the splash guard 292 is connected to the base 288 of the igniter assembly 286. The second end lip 299 extends from the bottom surface 296 of the splash guard 292 and is generally parallel to the base 288 of the igniter assembly 286. Thus, the bottom surface 296 and the two end lips 298, 299 of the splash guard 292 define a cavity 297. Preferably, the igniter 290 is at least partially positioned within the cavity 297 of the splash guard 292. The splash guard 292 can take on a variety of different configurations so long as the splash guard 292 includes a cavity 297 in which the igniter 290 is partially positioned.

The splash guard 292 protects the igniter 290 from being saturated by cleaning and rinsing solutions sprayed within the housing 214 during the cleaning cycle. Specifically, the heating element 226 is mounted within the housing 214 such that the apertures 282 in the top surface 278 of the body 272 of the burner face generally upwards towards the ceiling 221 of the housing 214. In this position, the igniter 290, which is proximate the apertures 282, also faces upwards toward the ceiling 221 of the housing 214. However, the splash guard 292 under which the igniter 290 is located protects the igniter 290 from saturation. Specifically, the igniter 290 is positioned within the cavity 297. Thus, sprayed fluids contact the top surface 294 of the splash guard 292 rather than the igniter 290.

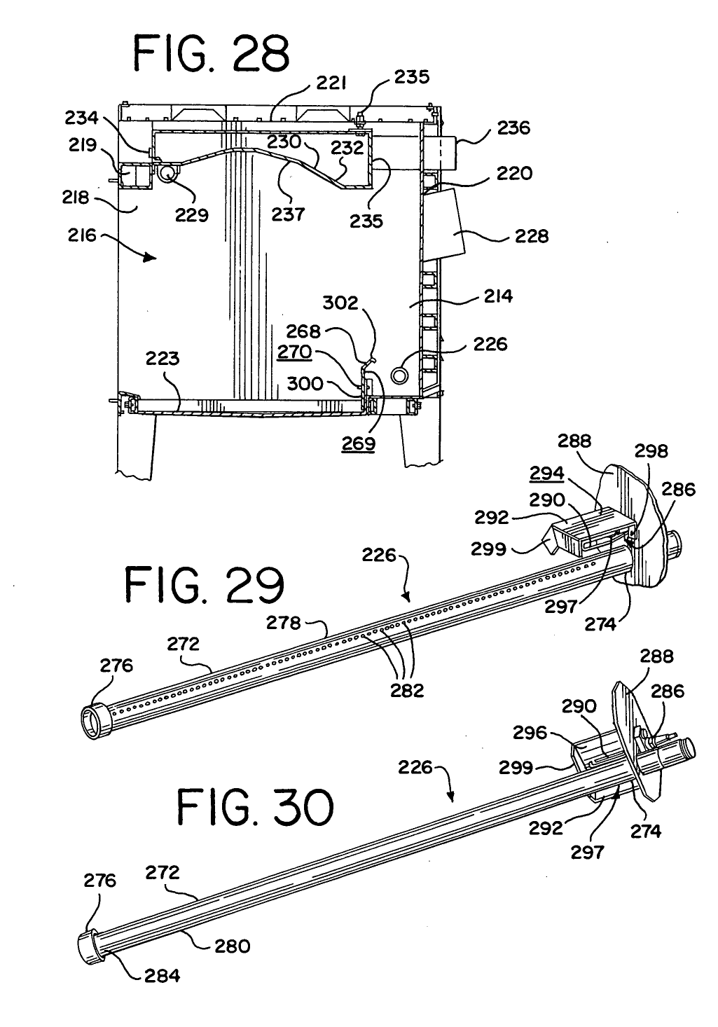

Like the first preferred embodiment, the oven 210 includes a blackbody radiator 230, best seen in FIGS. 26 and 28. The blackbody radiator 230 includes its own heating element 229 operably connected to the blackbody radiator 230, as seen in FIG. 29. Thus, the oven 210 includes both a blackbody radiator 230, having a heating element 229, and the separate heating element or burner 226 in the interior 216 of the housing 214. These components jointly heat the food items placed in the oven 210. In the second preferred embodiment of the oven 210, the blackbody radiator 230 is suspended in the interior of the housing. Suspension of the blackbody radiator 230 permits expansion and contraction of the blackbody radiator 230 during heating and cooling without warping or other damage to the housing 214. Specifically, the blackbody radiator 230 has a first side 231, a second side 233, a front edge 234 and a rear edge 235. Preferably, the front edge 234 of the blackbody radiator 230 rests on the crossbeam 219 of the first wall 218 of the oven, as seen in FIG. 26. A pair of fasteners 236 extend from the first side 231 of the blackbody radiator 230, near the rear edge 235, to connect or suspended the blackbody radiator 230 from the ceiling 221 of the housing 214, as shown in FIG. 28. In this way, the blackbody radiator 230 is suspended into the interior of the housing by the fasteners and the first edge of the blackbody radiator resting on the crossbeam. The blackbody radiator 230 is suspended such that the radiator 230 is spaced from the walls of the housing 214. For example, as shown in FIG. 28, a space is maintained between the ceiling of the housing 214 and an upper surface of the blackbody radiator 230. Although the preferred embodiment is illustrated in the Figures, the blackbody radiator 230 may be suspended in a variety of manners within the housing. For example, the front edge 234 of the blackbody radiator 230 may be suspended from the ceiling 221 of the housing 214, much like the rear edge 235. Alternatively, a plurality of crossbeams 219 may be utilized to eliminate the need for fasteners. Any number of suspension methods well known in the art may be used such that the blackbody radiator 230 is suspended within the housing 214 and not in direct contact with the housing 214. As described, a heating element is operably connected to the blackbody radiator 230. The design also minimizes the stress experienced by the housing 214 from expansion of the blackbody radiator 230 during heating. As can be understood from the suspended design, the space provides a thermal resistance between the heat source and the housing walls, therefore minimizing heat transfer between the two structures.

The self-cleaning system 240 of the second preferred embodiment of the oven 210 is schematically diagramed in FIG. 31. The self-cleaning system 240 generally includes a cleaning system 242, a rinsing system 243, a self filtering system 256, a controller 262 and a safety lock system 264. In an alternative embodiment, the self-cleaning system 240 may also include a rear burner baffle 268. The cleaning system 242, and the rinsing system 240 are both operably connected to the controller 262 such that the controller 262 is capable of engaging and disengaging each system 242, 248.

The cleaning system 242 generally comprises a cleaning solution reservoir 243, a first delivery conduit 244, a first pump 245, and a cleaning outlet 247 in communication with the interior 216 of the housing 214. In a preferred embodiment, the cleaning outlet 247 comprises a plurality of cleaning jets 246. The cleaning solution reservoir 243 is adapted to be filled and to retain a quantity of detergent or cleaning solution. The first delivery conduit 244 operably connects the cleaning solution reservoir 243 to the interior 216 of the housing 214, as seen in FIG. 31. Specifically, the first delivery conduit 244 may comprise a series of hoses, tubes, or pipes which together deliver cleaning solution from the reservoir 243 to the interior 216 of the housing 214. The first delivery conduit 244 terminates in the main or center shaft 227 operably connected to the drive mechanism 224. The center shaft 227 is generally tubular. The cleaning jets 246 are mounted on the center shaft 227 within the interior 216 of the housing 214. The first pump 245 is operably connected to the first delivery conduit 244 to pump cleaning solution from the reservoir 243 to the cleaning jets 246, as seen in FIG. 31. In this way, the first pump 245 draws cleaning solution from the cleaning solution reservoir 243, through the first conduit 244, and to the center shaft 227.

The rinsing system 248 comprises a water source 249, a water inlet valve 250, a second delivery conduit 251, a second pump 252, a rotary valve 253, and a rinsing outlet 241. In a preferred embodiment, the rinsing outlet 241 comprises a plurality of rinsing jets 255 operably connected to a rotary arm 254. The water source 249 may be any source capable of supplying pressurized water to the rinsing system, but preferably is a water pipe in communication with a pressurized water source. The second delivery conduit 251 connects the water source 249 to the interior 216 of the housing 214, as seen in FIG. 31. Specifically, the second delivery conduit 251 may comprise a series of hoses, tubes, or pipes which together deliver water from the water source 249 to the interior 216 of the housing 214. The second delivery conduit 251 terminates in the rotary arm 254 pivotally connected to the interior 216 of the housing 214. The rotary arm 254 is generally tubular and is free to rotate about its pivot point. The rinsing jets 255 are mounted on the rotary arm 254 within the interior 216 of the housing 214. Preferably, the rotary arm 254 is mounted near the bottom 223 of the housing 214. The second pump 252 is operably connected to the second delivery conduit 251 to pump water from the water source 249 to the rinsing jets 255, as seen in FIG. 31. The second pump 252 is operably connected inline between the water source 241 and the rotary arm 254. The rinsing system also includes the water inlet valve 250 and a rotary valve 253. As seen in FIG. 31, the water inlet valve 250 is operably connected inline between the water source 249 and the second pump 252. Also, the rotary valve 253 is operably connected inline between the second pump 252 and the rotary arm 254. As can be appreciated from FIG. 31, the cleaning system and rinsing system have independent fluid delivery flow paths.

The self filtering system 256 of the oven 210 is also illustrated in FIG. 31. The self filtering system 256 generally includes a filtering conduit 257, a filter 258, a center shaft valve 259, a drain conduit 260, and a drain valve 261. As seen in the FIGURES, the filter 258 is operably connected between the cleaning system 242 and the rinsing system 248 such that fluid passing through the systems 242, 248 is recirculated and filtered through the filter 258. Specifically, the input of the filter 258 is connected to the output of the second pump 252 by the filtering conduit 257. Also, the output of the filter 258 is connected to the input of the center shaft 227 by the filtering conduit 257. The center shaft valve 257 is operably connected inline between the filter 258 and center shaft 227. The self-filtering system 256 further includes the drain conduit 260 and the drain valve 261 operably connected to the filter 258, as seen in FIGS. 26 and 31. The drain conduit 260 extends from the filter 258 to permit drainage of waste filtered by the filter 258. The drain valve 261 is operably connected inline in the drain 260 and serves to open and close the drain conduit 260.

The self-cleaning system 240 also includes a controller 262 that is operably connected to the first pump 245, the second pump 252, the water inlet valve 250, the center shaft valve 259, the drain valve 261 and the rotary valve 253. The controller 262 can be any variety of mechanical or electro-mechanical controllers well known in the art. All that is required is that the controller 262 be able to operate the two pumps 245, 252 and the valves 250, 259, 261, 253 of the self cleaning system.

The self-cleaning system 240 also includes a safety lock system 264, the operation of which is depicted in FIG. 31. The safety lock system, or temperature lock system 264, includes a temperature sensor 265 and a switch 266 operably connected to the controller 262 of the self-cleaning system 240. The switch 266 is connected to the controller 262 of the self-cleaning system 240, to engage and disengage the controller 262, thereby preventing the controller 262 from activating the cleaning and rinsing systems 242, 248. Stated differently, the self-cleaning system 240 commences in response to a desired reading in a predetermined range from the sensor 265. Preferably, the switch 266 is integrated into the software of the controller 262. Specifically, the temperature sensor 265 monitors the temperature within the interior of the housing 214 of the oven 210 and sends a signal to the controller 262 when the temperature is within a desired range for performing cleaning of the oven 210. The controller 262 is operably connected to the switch 266 which engages and disengages the self-cleaning system 240. Thus, when the temperature of the oven 210 comes within the desired temperature for cleaning, the temperature sensor 265 sends a signal to the controller 262, which in turn activates the switch 266, thereby engaging the self-cleaning system 240. The use of the temperature lock system 264 prevents the self-cleaning system 240 from being activated when the temperature within the oven 210 is outside of the desired range. Preferably, the desired range is less than 175 degrees Fahrenheit. For example, if the temperature in the oven 210 is too hot, the cleaning and rinsing solutions may vaporize, making cleaning ineffective. Thus, because cleaning needs to occur within a desired temperature range, the temperature lock system 264 ensures that the self-cleaning system 240 operates only when the temperature of the interior 216 of the oven 210 is within that desired range. Preferably, the sensor 265 is mounted within the cavity or interior 216 of the housing 214 at a location shielded from the blackbody radiator 230. This allows the sensor 265 to read an ambient temperature within the interior 216 rather than an irradiated temperature from the blackbody radiator 230. In a preferred embodiment, the sensor 265 is a thermocouple positioned in the interior of the oven 210. Other temperature sensors may also be used.

The self-cleaning system 240 may also include a rear burner baffle 268 proximate the burner 226. It is understood that the rear burner baffle 268 is optional. The rear burner baffle 268 is best seen in FIGS. 27 and 28. The rear burner baffle 268 is cooperatively dimensioned with the burner and positioned proximate the burner 226 to shield the burner from direct contact with liquids which are sprayed within the housing 214 by the cleaning and rinsing systems 242, 248. The baffle 268 has an inside surface 269 and an outside surface 270. The inside surface 269 faces generally toward the burner 226, while the outside surface 270 faces generally away from the burner 226. The rear burner baffle 268 is not in direct contact with the burner 226, but rather is positioned so as to allow combustion gases being emitted from the burner 226 to flow into the interior 216 of the oven 214 with minimal restriction. However, the rear burner baffle 268 is also positioned adjacent to and close enough to the burner 226 to shield it from direct liquid spray. In one preferred embodiment, the baffle 268 has a generally vertical portion 300 and an angled portion 302 extending generally towards the burner 226. Preferably, the rear burner baffle 268 is made of metal to withstand the intense heat emitted from the burner 226. Thus, because it is metal, the rear burner baffle 268 provides an additional benefit in that it retains heat from the burner 226 and transmits radiant heat to the food item 212 during cooking.

The skewer and drive mechanism 224 of the second preferred embodiment of the oven 210 are the same as the elements by the same name described in the other embodiments.

During operation of the oven 210, fuel is forced into the first end 274 of the body 272 of the heating element or burner 226. The fuel travels through the hollow interior of the body 272 and out through the apertures 282 in the top surface 278 of the body 272. The igniter 290 is activated to ignite the fuel passing through the apertures 282 and light the burner 226. Continued flow of fuel into the first end 274 of the body 272, through the body 272, and out of the apertures 282 sustains burning of the heating element 226. The fuel can be any one of commonly used burner fuels, such as propane, natural gas, or other gases. The burning fuel heats the interior 216 of the housing 214 including the blackbody radiator 230. Thus, the oven 210 of the second preferred embodiment cooks food items 212 similar to the oven 210 of the first preferred embodiment. Thus, food items placed in the oven 210 are cooked by a combination of the blackbody radiator and the burner.

Following use of the oven 210 for cooking, the oven 210 can be cleaned using the self-cleaning system 240. The self-cleaning system 240 is fully automated and requires no operator intervention once initiated. The sensor 265 of the safety lock system 264 monitors the temperature within the interior 216 of the housing 214 of the oven 210 to ensure that the self-cleaning system 240 is activated only during the desired temperature range. Once the temperature inside of the oven 210 has reached the desired range, the switch 266 is activated to permit the controller 262 to operate the cleaning and rinsing systems 242, 248.

The first step of the self-cleaning process is the running of the cleaning system 242 to distribute cleaning solution throughout the interior 216 of the housing 214. During this process, the controller 262 closes the rotary valve 253, and the water inlet valve 250. The controller 262 opens the center shaft valve 259. Then, the controller 262 activates both the first and second pumps 245, 252. This causes the first pump 245 to pump cleaning solution from the cleaning solution reservoir 243, through the first conduit 244, through the center shaft 227, and through the cleaning jets 246. The cleaning solution is thus sprayed into the interior 216 of the housing 214, thereby coating substantially all surfaces of the interior 216 of the housing 214. The pressure of the cleaning system 242 is preferably relatively low to ensure maximum coverage of the cleaning solution. Furthermore, the size of the cleaning outlet 247 and cleaning jets 246 is relatively small such that the velocity of the cleaning fluid coming from the cleaning outlet 247 and cleaning jets 246 is slow. This low velocity assists in maximizing coverage of the cleaning solution in the interior 216 of the housing 214. Excess cleaning solution drips to the bottom 223 of the housing 214 of the oven where it exits the housing via the discharge opening 225. This excess solution is recirculated by the second pump 252 through the filtering conduit 257, the filter 258, the center shaft valve 259, and back into the center shaft 272. Upon passing through the filter 258, waste and debris are removed from the cleaning solution prior to it being reintroduced into the housing 214. The waste and debris are collected in the filter 258.

At the end of the cleaning cycle, the rinsing system 248 is then operated. The controller 262 deactivates the first pump 245, and closes the center shaft valve 259. The controller 262 also opens the water inlet valve 250 and the rotary valve 253, and continues operation of the second pump 252. The drain valve 261 remains closed. In this configuration, water from the water source 249 is pumped through the second delivery conduit 251 by the second pump 252, through the rotary valve 253, and into the rotary arm 254. Water passing through the rotary arm 254 is sprayed through the rotary jets 255, which cause the rotary arm 254 to pivot about its pivot point. Stated differently, the exit velocity and attack angle of the water passing through the rotary arm 254 and rotary jets 255 provides rotary motion to the rotary arm 254. This pivoting causes the rotary arm 254 to distribute the pressurized water over substantially all surfaces of the interior 216 of the housing, thereby rinsing them of left over debris and cleaning solution. The rotary arm 254 and rinsing jets 255 are configured and strategically positioned to cover every surface of the interior 216 as the rotary arm 254 rotates. The pressure of the rinsing system 248 is preferably higher than the pressure in the cleaning system 242, to ensure that a complete rinse and maximum cleaning is achieved. Furthermore, preferably the openings in the rinsing outlet 241 and rinsing jets 255 are larger than the openings in the cleaning outlet 247 and cleaning jets 246. These relatively larger openings ensure higher velocity of rinsing solution which assists in delivering a higher pressure, higher velocity rinsing solution into the interior 216 of the housing 214, whereby maximum rinsing is achieved. The waste solution of water, debris, and cleaning solution fall to the bottom 223 of the housing 214 where they exit through the discharge opening 225.

The controller 262 then opens the drain valve 261 and closes the rotary valve 253 which permits this waste solution to exit the system. Opening the drain valve 261 activates the self-cleaning process of the filter 258. Specifically, the waste solution is pumped by the second pump 252 through the filtering conduit 257, through the filter 258, and out of the drain conduit 260. The drain valve 261 is maintained in an open position during this process to discharge the waste solution from the system. When the housing 214 has been completely drained via the discharge opening 225, the controller closes all of the valves 261, 259, 253, 250, and deactivates both pumps 245, 252. The self-cleaning system 240 of the oven 210 has then completed the self-cleaning cycle, after which the oven 210 can be used again for cooking a food item 212 as described herein.

The configuration of the self-cleaning system 240 includes a self priming feature for the second pump 252 of the rinsing system 248. Specifically, the controller 262 permits a short burst of water to pass from the water source 249, through the second pump 252, through the filtering system 256, and into the center shaft 227. Because the water source 249 delivers pressurized water into the center shaft 227, the second pump 252 is primed automatically. Therefore, the second pump 252 need not be self-priming, as it is primed by the flow of pressurized water. In this way, the self-cleaning system 240 of the oven 210 includes the feature of being self-priming.

Various features of the oven 210 assist in toleration of the cleaning and rinsing fluids which are sprayed within the housing 214 of the oven 210. As discussed, the oven 210 is unique in that it has the burner 226 while also utilizing a spray down type of cleaning system 242. As described, the heating element or burner 226 of the second preferred embodiment includes improvements such that the heating element 226 better tolerates the cleaning cycle. The features which protect the burner 226 during the cleaning cycle are the splash guard 292, the drain opening 284, and the tilted nature of the positioning of the body 272 of the burner 226. These features work together to both protect the burner 226 from cleaning and rinsing fluids, while also assisting in permitting those fluids that do enter the burner 226 to drain out. Yet another feature that assists during the cleaning cycle is the rear burner baffle 268. Because the baffle 268 is mounted proximate the burner 226, it protects the burner 226 from excess saturation from the spraying of cleaning and rinsing solutions during the operation of the cleaning system 242 and the rinsing system 248. Specifically, the outside surface 270 of the baffle 268 protects the burner 226. Sprayed fluids in the interior 216 of the housing 214 center the outside surface 270 of the baffle 268, and thus avoid or minimize contact with the burner 226.

Thus, as can be seen from the description of the operation of the oven of the second embodiment, the oven offers a number of benefits from conventional ovens.

Firstly, the independent fluid delivery of the cleaning system and rinsing system is a significant benefit of the oven of the present invention. Because each system has its own pump, the cleaning system and rinsing system may be operated at different fluid pressures. During the cleaning system, it is preferable to maximize the amount of cleaning solution or detergent coating the interior surfaces of the oven. This is best done by spraying the cleaning solution through the cleaning system at a lower pressure to evenly coat such surfaces. Conversely, rinsing is more efficient when performed at higher pressures to minimize the amount of residue or waste left within the interior of the oven. The oven of the present invention maximizes the efficiency of both cleaning and rinsing through independent fluid delivery of the cleaning system and rinsing system.

Secondly, the self-cleaning filter offers a significant advantage to conventional filters which must be often cleaned manually or replaced. By using the pressurized water from the water source, the self-cleaning filter automatically removes collected particles of debris and waste down the drain.

Thirdly, the self-priming configuration of the self-cleaning system is a significant improvement over conventional systems in that the pumps utilized need not be self-priming. This provides a cost savings when manufacturing the oven, as well as a more practical oven which, due to its self-priming configuration, immediately draws fluids into operation during the cleaning and rinsing cycles, rather than requiring a delay for pressurization as is required with traditional pumps. Furthermore, because the second pump is primed by the self-priming feature of the self-cleaning system, the second pump can be located on the apparatus above the level of the liquid which it pumps, without the need for utilizing a self-priming pump.

Finally, the oven of the second embodiment offers numerous benefits by way of the self-cleaning system, and components better suited to tolerate the same. The oven is virtually maintenance free, capable of spraying cleaning solution, rinsing, filtering, and draining the same automatically without intervention from operators. Thus, the controller can be programmed to the specific needs for cooking and cleaning cycles of particular users.

These and other benefits are readily apparent from the description herein.

While the specific embodiment has been illustrated and described, numerous modifications come to mind without significantly departing from the spirit of the invention, and the scope of protection is only limited by the scope of the accompanying claims.

We claim:

1. An apparatus for cooking a food item therein comprising:
a housing; and
a heating element operably coupled to the housing, the heating element having a drain hole.

2. The apparatus of claim 1 wherein the heating element is a gas burner.

3. The apparatus of claim 1 wherein the heating element has a bottom surface and the drain hole is located in the bottom surface.

4. The apparatus of claim 1, further comprising an igniter.

5. The apparatus of claim 4 wherein the igniter is connected to the heating element.

6. The apparatus of claim 1 wherein the heating element has an angled configuration in the housing.

7. The apparatus of claim 1 further comprising a cleaning system having an outlet in communication with an interior of the housing.

8. An apparatus for cooking a food item therein comprising:
a housing defining an interior, the housing having a bottom surface; and
a heating element operably coupled to the housing to heat the housing, the heating element having a first end and a second end, the second end positioned closer to the bottom surface than the first end, the heating element further having a drain hole.

9. The apparatus of claim 8, wherein the drain hole is proximate the second end of the heating element.

10. The apparatus of claim 8 wherein the heating element is a gas burner.

11. The apparatus of claim 8, further comprising an igniter.

12. The apparatus of claim 11 wherein the igniter is connected to the heating element.

13. The apparatus of claim 8 wherein a portion of the heating element is hollow.

14. The apparatus of claim 13 wherein the heating element has a plurality of apertures.

15. The apparatus of claim 8 wherein the second end is approximately 1/4-inch closer to the bottom surface than the first end.

16. An apparatus for cooking a food item therein comprising:
a housing defining an interior, the housing having a bottom surface;
a heating element operably coupled to the housing, the heating element having a first end and a second end, the second end positioned closer to the bottom surface than the first end, the heating element further having a drain hole; and
a cleaning system having an outlet in communication with the interior.

17. An apparatus for cooking a food item therein comprising:
a housing having a portion made of a material comprising a blackbody radiator, the housing defining an interior adapted to receive the food item, the portion having an interior surface;
a burner operably coupled to the housing, the burner having a first end and a second end, the first end raised above the second end, the heating element further having a drain hole; and
a cleaning system having an outlet in communication with the interior.

18. An apparatus for cooking a food item therein comprising:
a housing defining an interior adapted to receive the food item;
a heating element operably coupled to the housing; and
a cleaning system having a first outlet in communication with the interior, the cleaning system adapted to spray liquid into the interior to clean the apparatus.

19. The apparatus of claim 18 wherein the apparatus further comprises a center shaft operably connected to the housing, wherein the outlet is operably connected to the center shaft.

20. The apparatus of claim 19 wherein the cleaning system further comprises a reservoir and a first delivery conduit operably connecting the reservoir to the first outlet.

21. The apparatus of claim 20 wherein the cleaning system further comprises a first pump operably connected to the first delivery conduit to draw liquid from the reservoir, through the first delivery conduit and to the first outlet.

22. The apparatus of claim 18 further comprising a rinsing system having a second outlet in communication with the interior, the rinsing system adapted to spray liquid into the interior to rinse the apparatus.

23. The apparatus of claim 22 wherein the rinsing system further comprises a rotary arm, wherein the outlet is operably connected to the rotary arm.

24. The apparatus of claim 23 wherein the rinsing system further comprises a water source and a second delivery conduit operably connecting the water source to the second outlet.

25. The apparatus of claim 24 wherein the rinsing system further comprises a second pump adapted to draw water from the water source, through the second delivery conduit, and to the first outlet.

26. The apparatus of claim 24 wherein the second pump is connected to a pressurized water source.

27. The apparatus of claim 18 wherein the heating element is a blackbody radiator.

28. The apparatus of claim 18 wherein the heating element is a burner.

29. The apparatus of claim 28 wherein the burner has a drain hole.

30. The apparatus of claim 28 wherein the burner is angled within the housing.

31. The apparatus of claim 28 further comprising a baffle positioned in the interior of the housing in communication with the burner.

32. The apparatus of claim 21 further comprising a rinsing system having a second outlet in communication with the interior, the rinsing system adapted to spray liquid into the interior to rinse the apparatus.

33. The apparatus of claim 32 wherein the rinsing system further comprises a rotary arm, wherein the outlet is operably connected to the rotary arm.

34. The apparatus of claim 33 wherein the cleaning system further comprises a water source and a second delivery conduit operably connecting the water source to the second outlet.

35. The apparatus of claim 34 wherein the rinsing system further comprises a second pump adapted to draw water from the water source, through the second delivery conduit, and to the first outlet.

36. The apparatus of claim 35 wherein the heating element is a burner.

37. The apparatus of claim 36 wherein the burner is angled within the housing.

38. The apparatus of claim 37 wherein the burner has a drain hole.

39. The apparatus of claim 38 further comprising a baffle positioned in the interior of the housing in communication with the burner.

40. The apparatus of claim 39 further comprising a blackbody radiator positioned within the interior.

41. The apparatus of claim 40 wherein the blackbody radiator is suspended in the interior.

42. The apparatus of claim 41 further comprising a self-cleaning filter.

43. The apparatus of claim 42 wherein the self-cleaning filter is operably connected to both the cleaning system and rinsing system.

44. The apparatus of claim 43 wherein the pressure in the rinsing system is greater than the pressure in the cleaning system.

45. The apparatus of claim 44 wherein the pressure in the second pump is greater than the pressure in the first pump.

46. An apparatus for cooking a food item therein comprising:
a housing defining an interior adapted to receive the food item;
a heating element operably coupled to the housing; and
a cleaning system having a first outlet in communication with the interior, the cleaning system adapted to spray liquid into the interior to clean the apparatus, and
means for controlling the cleaning system based upon the temperature in the interior.

47. An apparatus for cooking a food item therein comprising:
a housing defining an interior adapted to receive the food item;
a heating element operably coupled to the housing; and
a cleaning system having a first outlet in communication with the interior, the cleaning system adapted to spray liquid into the interior to clean the apparatus, and
a baffle operably positioned in the interior proximate the burner.

48. An apparatus for cooking a food item therein comprising:
a housing defining an interior adapted to receive the food item;
a blackbody radiator suspended within the interior of the housing; and
a heating element operably coupled to the radiator to heat the interior.

49. The apparatus of claim 48 wherein the blackbody radiator emits radiation towards the food item generally within the 3-10 μm wavelength.

50. The apparatus of claim 48 wherein the housing includes a crossbeam, and a portion of the blackbody radiator rests on the crossbeam.

51. The apparatus of claim 48 further comprising a plurality of fasteners connecting the blackbody radiator to the housing.

52. The apparatus of claim 48 wherein housing has a ceiling and the blackbody radiator is suspended from the ceiling.

53. The apparatus of claim 48 further comprising a plurality of fasteners connecting the blackbody radiator to the ceiling.

54. The apparatus of claim 48 wherein the blackbody radiator has a curvilinear configuration.

55. The apparatus of claim 48 wherein a space is maintained between the blackbody radiator and an inner surface of the housing.

56. The apparatus of claim 48 wherein a space is maintained between a coiling of the housing and an upper surface of the blackbody radiator.
